(19) United States
(12) Patent Application Publication
(10) Pub. No.: US 2010/0261034 A1
(43) Pub. Date: Oct. 14, 2010

(54) COMPOSITE METALLIC MATERIALS, USES THEREOF AND PROCESS FOR MAKING SAME

(76) Inventor: François Cardarelli, Montreal (CA)

Correspondence Address: FULBRIGHT & JAWORSKI L.L.P., 600 CONGRESS AVE., SUITE 2400, AUSTIN, TX, 78701, US

(21) Appl. No.: 12/376,710

(22) PCT Filed: Aug. 7, 2007
(86) PCT No.: PCT/CA07/01385

§ 371 Date: May 19, 2010

Related U.S. Application Data
(60) Provisional application No. 60/835,870, filed on Aug. 7, 2006.

(51) Int. Cl. B32B 15/01; B32B 15/04; B05D 3/00; C25D 5/00; B44C 1/22

(52) U.S. Cl. 428/615; 428/457; 428/688; 427/299; 427/327; 427/328; 205/80; 216/53

(57) ABSTRACT

A lightweight, high strength and corrosion resistant composite metallic material is disclosed herein. The composite metallic material typically comprises a high-to-weight ratio, low density core material; and a corrosion resistant protective refractory metal layer. The method for making the composite metallic material comprises the steps of surface activating the core material and forming a refractory metal on the surface of the surface activated core material by physical, chemical or electrochemical processes. Such a composite material is suitable for making biomaterials, corrosion resistant equipment and industrial electrodes.

### FIELD OF THE INVENTION

The present disclosure relates to composite metallic materials, uses thereof and a process for making such materials. More specifically, but not exclusively, the present disclosure relates to lightweight, high strength and corrosion resistant metallic composite materials, uses thereof, as well as to a process for making such materials. The present disclosure also relates to metallic composite materials suitable for making biomaterials, industrial electrodes and corrosion resistant equipment.

### BACKGROUND OF THE INVENTION

Today, surgical and orthopedic implants, along with prosthetic devices such as hip and knee joints, femoral repairs, bone plates and dental implants, made of high strength metals and alloys, are widely used in medicine. In addition, due to the rapid aging of the world population, the number of persons requiring replacement of failed hard tissue is expected to greatly increase (1).

Four main classes of metallic biomaterials have been historically used to manufacture surgical implants and prosthetic devices:

(i) stainless steels such as the AISI grade 316L; these materials constitute the first materials to be successfully used owing to their good corrosion resistance [their specifications are described in the standard ASTM F138-03 (2)];

(ii) cobalt-based alloys (Co—Cr—Mo alloys), commercialized under the trade name Vitallium®; these materials were subsequently introduced owing to their high strength-to-weight ratio [their specifications are described in the standard ASTM F75-01 (3)];

(iii) titanium and its alloys; introduced during the last few decades, constitute superior metallic biomaterials owing to their excellent biocompatibility, strength-to-weight ratio and balance of mechanical properties (4) [the specifications of chemically pure titanium are described in standard ASTM F67-00 (5) whereas the specifications of Ti-6Al-4V ELI are described in ASTM F136-02a (6)]; and

(iv) shape memory alloys (SMAs), especially nickel-titanium alloy (55 wt. % Ni: 45 wt. % Ti or simply 55Ni-45Ti), known commercially under the common acronym NiTiNOL, have been the latest metallic biomaterials [their specifications are described in ASTM 2063-05 (7)].

In practice, metallic implants must exhibit high strength in order to prevent fatigue related breakage, and more importantly, they must be biocompatible. However, high strength also implies a high degree of stiffness. Implants that are too rigid do not provide for functional loading of the bone bridged by the implant, leading to dangerous weakening of the bone substance or decalcification and further fractures. An important parameter for quantifying this critical behavior is the dimensionless ratio of tensile strength to Young's or elasticity modulus (σ_{YS}/E). For instance, for Vitallium®, the ratio is roughly equal to 1450 MPa/248 GPa, whereas for the titanium alloy Ti-6Al-4V the ratio is 800 MPa/106 GPa. The titanium alloy exhibits a higher ratio and a lower Young's modulus, leading to a better match with the mechanical properties of hard tissues.

It is important that biomaterials be biocompatible with the human body, without causing adverse reactions therewith (8,9). A biocompatible material (i.e. biomaterial) must comply with the following criteria:

(i) high corrosion resistance with respect to body fluids, (e.g. by developing a protective and impervious passivating layer) and being dimensionally stable;

(ii) low cytotoxicity;

(iii) non-ferromagnetic (e.g. avoiding dislodging in a strong magnetic field such as during magnetic resonance imaging (MRI));

(iv) high-strength-to-weight ratio;

(v) high resistance to cycle loading;

(vi) low fretting fatigue; and

(vii) providing for surface treatments permitting adhesion of biocompatible ceramic coatings.

Even though in commercial use, none of the previously mentioned classes of metallic biomaterials fully satisfies all of the above criteria.

Stainless steels containing large amounts of chromium (to improve corrosion resistance) and nickel (an austenite stabilizer) can release traces of harmful alloying elements as deleterious metal cations (e.g. Ni²+ and/or Cr⁶⁺ ) over extended periods of time when put into contact with body fluids (e.g. blood). Moreover, their Young's modulus is quite high (˜200 GPa) compared to that of bones (30 GPa).

Similarly, cobalt-based alloys, despite being more corrosion resistant, have been alleged to be associated with metal allergies due to the in-situ release of traces of metal cations (e.g., Co²⁺ and Cr⁶⁺ ). Moreover, their elevated Young's modulus, compared to that of bones, represents a further important drawback.

Titanium and its alloys exhibit excellent corrosion resistance, are not known to release traces of alloying elements and have a Young's modulus (110 GPa) closely resembling that of hard tissue. Beta titanium alloys, such as the well known ASTM grade 5 or Ti-6Al-4V ELI are favored alloys. However, the potential release of vanadium could adversely affect the long term biocompatibility. A potential similar release of nickel could adversely affect the long term biocompatibility of NiTiNOL.

More inert and noble metals have also been envisaged as potential biomaterials. Pure tantalum, niobium, zirconium and titanium comprise some of the better candidates in terms of biocompatibility. Tantalum exhibits excellent corrosion resistance, due to its propensity to create a protective and impervious passivating layer. Moreover, the chemical reactivity of tantalum is comparable to that of borosilicated glass. Yet moreover, due to its high atomic number and its excellent radiopacity, tantalum facilitates identification on radiographs. Finally, tantalum exhibits good ductility and workability, making it an excellent candidate for implantation in the human body as a surgical or medical device. It has been previously demonstrated that cold-worked tantalum exhibits fatigue strength comparable to the best cobalt-based alloys, despite the fact that it exhibits only about half the ultimate tensile strength at similar elongation (10). Similarly good results have been obtained with niobium.

Due to its greater ductility and very low propensity to stress-corrosion, tantalum, and to a lesser extend niobium, constitute interesting alternatives to the ultra high strength Co-based alloys presently in use as biomaterials (11). Although there is a history of successful animal experimentation and clinical use spanning more than 50 years, the modern use of tantalum has been strongly limited mainly because of its high density (16,654 kg/m³) and high cost (550 $US/kg), preventing any commercial use of bulk tantalum for large prosthetic implants.

The deposition of a thin tantalum coating onto a less dense, higher strength and less expensive base metal (e.g. steels) has been proposed in order to overcome some of the previously mentioned drawbacks. These composite materials exhibit both the outstanding surface properties of tantalum (e.g. corrosion resistance, biocompatibility) and the bulk properties of the base metal (e.g. elevate tensile strength). Several commercial techniques for producing such coatings on an industrial scale are known in the art.

Cardarelli et al. have shown that among the plethora of coating techniques, thin, coherent and impervious tantalum coatings can be obtained by means of tantalum electroplating in molten alkali metal fluorides (12). Several base metals including iron, copper, nickel, and stainless steels were successfully coated with tantalum (13).

U.S. Pat. No. 4,969,907 issued to Koch et al. on Nov. 13, 1990 discloses bone implants made by spot welding tantalum onto a metallic substrate. However, this technique suffers from the drawback of not providing a tight and intimate bond between the base metal and the outer protective layer. Furthermore, it requires a thick and expensive sheet of tantalum metal.

Explosion cladding comprises a widely used technique for manufacturing large plates (14). However, explosion cladding requires flat surfaces having a thick base plate and lacking intricate shapes and geometries such as commonly encountered with bone implants.

A biomaterial comprising a thin tantalum coating deposited onto a Co—Cr—Mo alloy substrate, either by molten salt electrolysis or by chemical vapor deposition, has been described by Christensen, J. in Unites States Patent Application No. 2004/0068323 published on Apr. 8, 2004. However, the material still exhibits a high strength-to-elasticity ratio, in addition to exhibiting elevated density. Moreover, a refined electrochemical technique for depositing tantalum by means of pulsed electrolysis, yielding ductile alpha tantalum, has been described by Christensen, et al. in WO 02/068729 published on Sep. 5, 2002.

The replacement of the heavy substrates with a lighter metal having a high strength-to-density ratio and a lower Young's modulus, especially titanium and titanium alloys, and to a lesser extend zirconium and its alloys, scandium, aluminum alloys, magnesium and magnesium alloys, provides for composite materials more closely resembling the properties of bone. However, the deposition of tantalum onto a titanium or titanium alloy substrate by means of molten salt electrolysis has not been possible due to the dissolution of the base metal. Moreover, reactive metals such as titanium or zirconium alloys cannot be plated with tantalum or niobium in such melts because of their rapid corrosion prior to the deposition of the tantalum or niobium coating.

The preparation of anodes comprising a titanium metal substrate having an intermediate tantalum coating layer, by means of coating with an IrO₂—Ta₂O₅ electrocatalyst has been disclosed by Kumagai et al. (15). The intermediate tantalum layer was deposited by means of a sputtering technique. However, this technique suffers from the drawback of not providing for good adhesion of the tantalum coating, resulting in peeling and subsequent delamination of the coating. Moreover, the long deposition times (e.g. 2 μm/h) required to obtain an impervious layer are not compatible with industrial production requirements.

The present disclosure refers to a number of documents, the contents of which are herein incorporated by reference in their entirety.

### SUMMARY OF THE INVENTION

The present disclosure broadly relates to novel lightweight, high strength, corrosion resistant metallic composite materials and uses thereof. The composite materials typically comprise a high strength-to-weight ratio, low density core material; and a refractory, corrosion resistant protective layer. The present disclosure also relates to a process for making lightweight, high strength, corrosion resistant composite metallic materials.

The present disclosure also relates to a process for preparing a lightweight, corrosion resistant composite metallic material. The process typically comprises providing a high strength-to-weight ratio, low density core material; and providing the core material with a refractory, corrosion resistant protective layer.

In an embodiment, the present disclosure relates to lightweight, high strength, conductive and corrosion resistant biocompatible composite metallic materials.

More specifically, as broadly claimed, the present disclosure relates to a lightweight, corrosion resistant composite metallic material comprising: (i) a high strength-to-weight ratio, low density core material; and (ii) a refractory and corrosion resistant layer.

More specifically, as broadly claimed, the present disclosure relates to a lightweight, corrosion resistant composite metallic material comprising: (i) a high strength-to-weight ratio, low density core material; and (ii) a refractory and corrosion resistant coating layer.

In an embodiment, the present disclosure relates to lightweight, corrosion resistant composite biomaterials comprising: (i) a high strength-to-weight ratio, low density core material; and (ii) a refractory and corrosion resistant layer.

In an embodiment, the present disclosure relates to lightweight, corrosion resistant composite biomaterials comprising: (i) a high strength-to-weight ratio, low density core material; and (ii) a refractory and corrosion resistant coating layer.

The foregoing and other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a fragmented perspective view of a representative portion of a composite metallic material according to an embodiment of the present disclosure showing a core material 10, an intermediate coating layer 20 and an outer protective coating layer 30;

FIG. 2 shows: (a) a perspective view of a composite metallic material according to an embodiment of the present disclosure showing a core material 40 an intermediate layer 50 and an outer protective layer 60; and (b) a perspective view of a composite metallic material according to an embodiment of the present disclosure showing a core material 40 and an outer protective layer 60;

FIG. 3 shows a flowchart illustrating an exemplary process for making a composite metallic material according to an embodiment of the present disclosure; and

FIG. 4 is a schematic illustration of exemplary applications of the composite materials of the present disclosure.

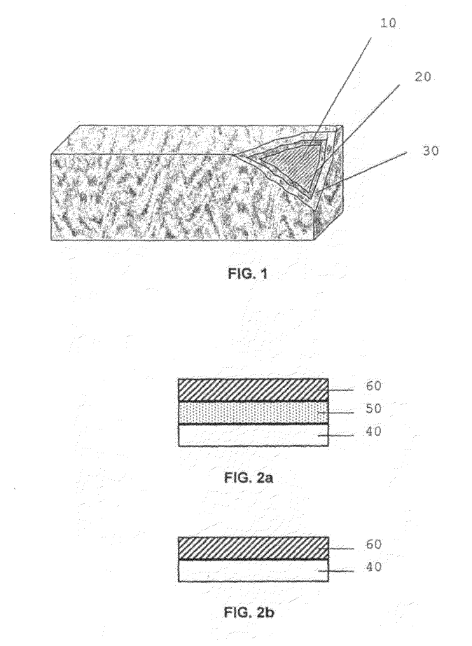

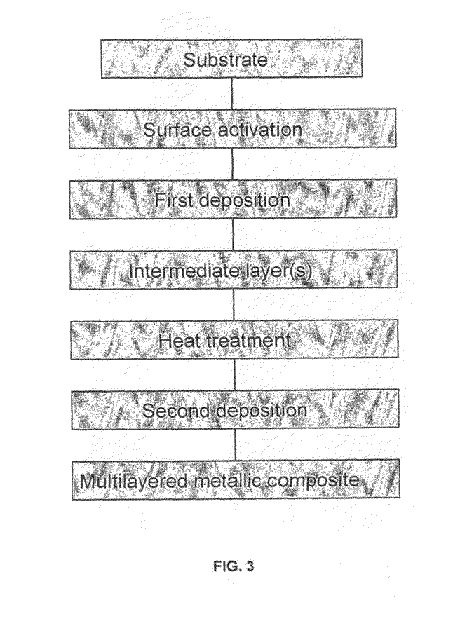

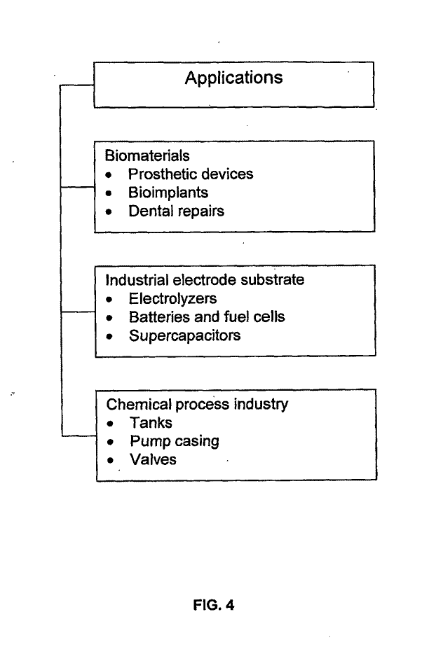

### DETAILED DESCRIPTION OF ILLUSTRATIVE EMBODIMENTS

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

As used in this specification, the term “metallic” refers to all metal-containing materials. This includes but is not limited to pure metals, metalloids, metal alloys and similar combinations that would be obvious to a skilled technician.

As used in this specification, the term “coating layer” refers to a generally continuous layer formed by a material over or on a surface of an underlying material.

As used in this specification, the term “high strength” refers to a tensile strength of at least 30 Mpa

As used in this specification, the term “low density” refers to a density below about 8000 kg/m³.

The present disclosure broadly relates to novel lightweight, high strength, corrosion resistant metallic composite materials comprising: (i) a high strength-to-weight ratio, low density core material; and (ii) a refractory and corrosion resistant layer. In an embodiment of the present disclosure, the materials may further comprise an intermediate layer comprising a more noble metal or an alloy thereof, the intermediate layer being disposed between the core material and the outer refractory and corrosion resistant layer. Such composite materials comprise suitable biomaterials. In an embodiment of the present disclosure, the composite material comprises a multilayered structure.

The present disclosure broadly relates to novel lightweight, high strength, corrosion resistant metallic composite materials comprising: (i) a high strength-to-weight ratio, low density core material; and (ii) a refractory and corrosion resistant coating layer. In an embodiment of the present disclosure, the materials may further comprise an intermediate coating layer comprising a more noble metal or an alloy thereof, the intermediate coating layer being disposed between the core material and the outer refractory and corrosion resistant coating layer. Such composite materials comprise suitable biomaterials. In an embodiment of the present disclosure, the composite material comprises a multilayered structure.

Selected mechanical properties of biomaterials (16) are illustrated hereinbelow in Table 1.

TABLE 1
Selected mechanical properties of biomaterials.

| | | | Young's | | |
|---|---|---|---|---|---|
| | Chemical | Density | modulus | Yield strength | Price |
| Metal or alloy | composition | (ρ/kg · m⁻³) | (E/GPa) | (σ_{YS}/MPa) | (P/US$ · kg⁻¹) |
| Titanium ASTM | Ti 99.8 | 4512 | 110 | 300 | 55 |
| grade 2 | | | | | |
| Titanium ASTM | Ti-6Al-4V | 4420 | 106 | 808 | 95 |
| grade 5 | | | | | |
| Zirconium 702 | (Zr + Hf) | 6510 | 100 | 300 | 230 |
| Tantalum | Ta 99.9 | 16654 | 179 | 180 | 550 |
| Stainless steel | Fe-18Cr-10Ni | 7800 | 190 | 190-1213 | 22 |
| grade 316LVM | | | | | |
| annealed | | | | | |
| Vitalium | Co—Cr—Mo—W | 8500 | 248 | 1450 | 40 |
| NiTiNOL | 55Ni-45Ti | 6450 | 21-83 | 500 | n.a. |
| Bone | | 2300 | 30-40 | n.a. | — |

The core material comprises a high strength-to-weight base metal having a Young's modulus resembling that of hard tissues. Non-limiting examples of core materials include titanium metal, titanium alloys, zirconium metal, zirconium alloys, aluminum metal, aluminum alloys, scandium metal, scandium alloys, magnesium metal, magnesium alloys, high melting point aluminum-scandium alloys, shape memory alloys, metal matrix composites (MMC), and carbon-based materials. Non-limiting examples of metal matrix composites include aluminum metal reinforced by fibers of boron carbide (Boralyn®) and magnesium alloy grade AZ91 reinforced by fibers silicon carbide (SiC). In an embodiment of the present disclosure, the shape memory alloy comprises NiTiNOL. In an embodiment of the present disclosure, the metal matrix composite comprises Boralyn®. In an embodiment of the present disclosure, the carbon-based material comprises pyrrolytic graphite.

The refractory and corrosion resistant material comprises a refractory metal selected from the group consisting of titanium, titanium alloys, zirconium, zirconium alloys, hafnium, hafnium alloys, vanadium, vanadium alloys, niobium, niobium alloys, tantalum, tantalum alloys, chromium, chromium alloys, molybdenum, molybdenum alloys, tungsten, tungsten alloys, iridium, iridium alloys, rhenium and rhenium alloys. In an embodiment of the present disclosure, the refractory and corrosion resistant material provides an outer impervious coating layer. In an embodiment of the present disclosure, the refractory and corrosion resistant material provides an outer impervious layer. The outer impervious layer or coating layer may be applied by means of electrolysis in molten salts. Alternatively, the outer impervious layer or coating layer may be applied by means of metalliding (i.e. current-less electrolysis) in a molten salt electrolyte. Alternatively, the outer impervious layer or coating layer may be applied by means of chemical vapor deposition (CVD) or by physical vapor deposition (PVD).

The material comprising the intermediate layer or intermediate coating layer includes a more noble metal or alloy thereof. Non-limiting examples of such materials include iron, iron alloys, nickel, nickel alloys, cobalt, cobalt alloys, copper, copper alloys, gold, gold alloys, chromium, chromium alloys, platinum group metals (e.g. ruthenium, rhodium, palladium, osmium, iridium, platinum) and platinum group metal alloys (e.g. ruthenium alloys, rhodium alloys, palladium alloys, osmium alloys, iridium alloys, platinum alloys). In an embodiment of the present disclosure, the intermediate layer comprises a thin layer which may be deposited onto the core material either by electrochemical, physical or chemical deposition techniques. In an embodiment of the present disclosure, the intermediate coating layer comprises a thin coating layer which may be deposited onto the core material either by electrochemical, physical or chemical deposition techniques.

The adhesion between the core material and the refractory and corrosion resistant material may be further enhanced by means of heat treatment. Alternatively, the adhesion between the core material, the intermediate material and the refractory and corrosion resistant material may be further enhanced by means of heat treatment. Heat treatment favors diffusion bonding between all layers/coatings and prevents delamination. Diffusion bonding is particularly efficient between layers/coatings of materials (e.g. metals) selected according to their ability to form solid solutions or intermetallic phases (i.e. Ti—Ni, Ni—Ta). Selected intermetallic combinations are illustrated hereinbelow in Table 2.

TABLE 2
Intermetallic combinations.

| | Metal 2 | | | | | |
|---|---|---|---|---|---|---|
| Metal 1 | Chromium | Iron | Cobalt | Nickel | Copper | Gold |
| Titanium | yes | yes | yes | yes | yes | yes |
| Zirconium | yes | yes | yes | n.a. | yes | yes |
| Hafnium | yes | yes | yes | yes | yes | yes |
| Niobium | yes | yes | yes | yes | no | yes |
| Tantalum | yes | yes | yes | yes | no | n.a. |
| Aluminum | yes | yes | yes | yes | yes | yes |
| Scandium | yes | yes | yes | yes | n.a. | yes |

In an embodiment, the metallic composite materials of the present disclosure may be used as biomaterials for applications including but not limited to implants and dental repair. In a further embodiment, the metallic composite materials of the present disclosure may be used as dimensionally stable monopolar or bipolar industrial electrode materials for applications including but not limited to electrolyzers, batteries, fuel cells and supercapacitors. In yet a further embodiment, the metallic composite material of the present disclosure may be used as corrosion resistant materials for manufacturing applications including but not limited to piping, valves, pumps, pump casings, impellers, tanks, and pressure vessels.

In an embodiment, the metallic composite materials of the present disclosure comprise a high strength-to-weight ratio titanium metallic core, electroplated in a molten salt with a refractory and corrosion resistant tantalum or niobium layer. The core may optionally be plated with a more noble metal intermediate layer. The layers are subsequently heat treated ensuring diffusion bonding between all layers. The composite materials may be used as biomaterials, electrocatalytic bipolar electrodes or as corrosion resistant materials.

In an embodiment, the metallic composite materials of the present disclosure comprise a high strength-to-weight ratio titanium metallic core, electroplated in a molten salt with a refractory and corrosion resistant tantalum or niobium coating layer. The core may optionally be plated with a more noble metal intermediate coating layer. The coatings are subsequently heat treated ensuring diffusion bonding between all coatings. The composite materials may be used as biomaterials, electrocatalytic bipolar electrodes or as corrosion resistant materials.

The refractory base metals titanium, zirconium, their respective alloys, aluminum and the rare earth metal scandium, readily form an insulating passivating oxide layer protecting the underlying base metal when anodically polarized, or when immersed in a corrosive media containing oxygen. The propensity to forming a passivating oxide layer is commonly know in the art as the “valve action (VA) property”. It is important that the passivating oxide layer be removed in order to ensure the formation of an excellent “bond” (i.e. adhesion) between the base metal (i.e. substrate) and the intermediate layer or coating layer. Moreover, the formation of a passivating oxide layer must also be prevented during the coating operations. The removal and the prevention of a passivating oxide layer may be accomplished using chemical, physical or electrochemical methods. In light of the present disclosure, it is believed to be within the capacity of a skilled technician to determine a suitable method. The compulsory removal of the passivating oxide layer and the prevention thereof is known as the “surface activation” of the base metal.

Prior to performing the surface activation of the base metal or an alloy thereof (i.e. substrate), the workpiece may be prepared according to precise specifications (e.g. size, shape) by means of common methods including forging, casting, molding, powder metallurgy, or machining techniques. In light of the present disclosure, it is believed to be within the capacity of a skilled technician to determine a suitable method. Any dimensional changes to the workpiece resulting from subsequent work done thereon (e.g. surface activation, plating, electroplating, and coating) can be accurately calculated and taken into consideration when manufacturing the workpiece.

Firstly, in order to remove grease and dirt, the base metal or an alloy thereof may be degreased by means of an organic solvent. Non-limiting examples of suitable organic solvents include hexanes, acetone, trichloroethylene and dichloromethane. In light of the present disclosure, it is believed to be within the capacity of a skilled technician to determine and select other suitable solvents. Alternatively, the base metal or an alloy thereof can be cleansed by means of a caustic alkaline solution. A non-limiting example of a suitable caustic alkaline solution comprises potassium hydroxide in ethanol. In light of the present disclosure, it is believed to be within the capacity of a skilled technician to determine and select other suitable caustic alkaline solutions. Alternatively, the base metal or an alloy thereof can be cleaned by means of electrocleaning. In an embodiment of the present disclosure, in order to avoid hydrogen embrittlement, the base metal or an alloy thereof was degreased using an organic solvent.

Secondly, once degreased, the passivating oxide layer protecting the underlying base metal or alloy thereof (e.g. workpiece) is removed. This can be accomplished using chemical, physical or electrochemical methods. In an embodiment of the present disclosure, the passivating layer is removed by means of sandblasting. An abrasive such as corundum, rather than silica, is commonly used in the sandblasting operation in view of its higher Mohs hardness (9 vs. 7). Moreover, corundum poses less of an occupational hazard compared to crystalline silica, and its embedded particles are more readily removed from the base metal (or alloy) surface. The sandblasted workpiece is subsequently rinsed using distilled or deionized water, and optionally sonicated in an ultrasound bath for about 5 minutes in order to remove any embedded corundum particles. In a further embodiment of the present disclosure, the passivating layer is removed by means of grinding. In light of the present disclosure, it is believed to be within the capacity of a skilled technician to determine and select other suitable methods.

Thirdly, to complete the surface activation, the surface of the sandblasted workpiece is typically etched by means of either chemical or electrochemical methods. Several etching reagents and etching methods are known in the art. For instance, titanium and its alloys (e.g. workpiece) may be etched by immersion into: (i) a boiling 10 wt. % aqueous oxalic acid solution; (ii) a boiling 20 wt. % aqueous hydrochloric acid solution; (iii) a boiling 30 wt. % aqueous sulfuric acid solution; or (iv) immersing the workpiece into a bath comprising a mixture of nitric and hydrofluoric acid, followed by immersing into a stop bath comprising a mixture of nitric and sulfuric acid and rinsing with deionized water to ensure complete removal of any residual etchant.

In an embodiment of the present disclosure, an intermediate layer or coating layer is deposited on the workpiece by chemical, physical or electrochemical means, following surface activation thereof. When the intermediate layer or coating layer is to be deposited by means of electroplating, the workpiece is typically immersed in an aqueous electrolyte or in a bath comprising cations of the nobler metal to be deposited. In this electroplating process, the workpiece (the cathode) is connected to the negative pole of a direct current power supply. The cations of the nobler metal to be deposited are typically supplied either by the dissolved solute and a soluble anode of the metal to be deposited, or, alternatively, by the dissolved solute only (in cases where an insoluble anode is used in place of a soluble anode). Non-limiting examples of nobler metals to be plated include Fe, Co, Ni, Cu, Cr, Ru, Rh, Pd, Os, Ir, Pt and Au. In light of the present disclosure, it is believed to be within the capacity of a skilled technician to determine and select other nobler metals to be plated.

The electroplating of iron, cobalt, nickel, copper, chromium, platinum group metals (e.g. ruthenium, rhodium, palladium, osmium, iridium, and platinum) or gold can be accomplished in one step or in two consecutive steps by either direct or pulsed electrolysis. When adhesion of the intermediate layer is of concern, a strike plate of the nobler metal having a thickness of a few microns is first deposited onto the substrate prior to the final deposition of the thicker intermediate layer.

Because of the poor adherence of the nobler metals (i.e. intermediate layer or intermediate coating layer) on base metals such as titanium and zirconium (e.g. Fe on Ti; Ni on Ti), even after surface activation and having applied a strike plate, heat treatment is typically performed over a period of several hours at temperatures ranging from about 200° C. to about 1200° C. to prevent catastrophic delamination between the substrate and the intermediate layer or intermediate coating layer. Heat treatment ensures good adhesion between the base metal or alloy thereof (e.g. workpiece) and any subsequent layers or coating layers by favoring diffusion bonding therebetween and can be performed under inert atmosphere, vacuum or in a molten salt bath.

In an embodiment of the present disclosure, a refractory and corrosion resistant layer or coating layer is deposited by means of electroplating, following the deposition of the diffusion bonded intermediate layer or coating layer. Non-limiting examples of refractory materials include tantalum, niobium, molybdenum, tungsten, and rhenium. In light of the present disclosure, it is believed to be within the capacity of a skilled technician to determine and select other refractory metals suitable for producing a refractory and corrosion resistant layer or coating layer. The deposition of the refractory and corrosion resistant layer or coating layer may be accomplished by chemical, physical or electrochemical means. In an embodiment of the present disclosure, tantalum is electrodeposited onto a plated titanium workpiece by means of electrolysis in a molten salt electrolyte. The electrodeposition of the refractory and corrosion resistant layer or coating layer may be accomplished by either direct or pulsed electrolysis. Alternatively, the refractory and corrosion resistant layer or coating layer may be deposited by means of metalliding (i.e. current-less electrolysis).

When the refractory and corrosion resistant layer or coating layer is to be deposited by means of electroplating, the plated workpiece is immersed in a molten salt electrolyte comprising cations of the refractory metal to be deposited. In an embodiment of the present disclosure, the electrolyte is a room temperature molten salt. In an embodiment of the present disclosure, the electrolyte is a high temperature molten salt. In yet a further embodiment of the present disclosure, the electrolyte is an ionic liquid. In this electroplating process, the plated workpiece (the cathode) is connected to the negative pole of a direct current power supply. The cations of the refractory and corrosion resistant metal to be deposited are typically supplied either by the dissolved solute and a soluble anode of the metal to be deposited, or, alternatively, by the dissolved solute only (in cases where an insoluble anode is used in place of a soluble anode). In an embodiment of the present disclosure, the corrosion resistant layer or coating layer comprises tantalum. In yet a further embodiment of the present disclosure, the tantalum comprising layer or coating layer is deposited under constant current until a desired thickness is obtained.

When the refractory and corrosion resistant layer or coating layer is deposited by means of metalliding, the refractory and corrosion resistant layer or coating layer diffuses into the underlying intermediate layer or intermediate coating layer due to the high temperatures of the metalliding bath (comprising a high temperature molten salt electrolyte). In an embodiment, the present disclosure relates to a metal plated titanium workpiece comprising a tantalum refractory and corrosion resistant layer or coating layer.

Following the electrodeposition of the refractory and corrosion resistant layer or coating layer, the workpiece can be either removed from the electrolyte bath or maintained therein to further ensure effective diffusion bonding between all constituent materials. The thickness of the refractory and corrosion resistant layer or coating layer is generally in the order of several micrometers. Due to a precise control over the electrodeposition conditions, notwithstanding the removal of traces of solidified electrolyte from the surface of the finished workpiece, no further treatment is typically required. Any traces of solidified electrolyte are readily removed by simple and/or ultrasonic washing in deionized water.

In an embodiment, the composite materials of the present disclosure provide a cost-effective alternative over the traditional high strength materials and alloys presently in use. As a non-limiting example, considering the price and bulk density of both titanium and tantalum (Table 1), a tantalum plated titanium object having similar corrosion properties as pure tantalum is 38 times less expensive than an identical object made entirely of bulk tantalum metal.

Depending on the nature of the core material, the type of intermediate layer or coating layer, and the type of refractory and corrosion resistant layer or coating layer, several industrial applications may be envisaged for the metallic composite materials of the present disclosure.

In an embodiment, the composite materials of the present disclosure exhibit mechanical properties (e.g. high-strength-to-weight ratio and low density) corresponding to those of the bulk core material (e.g. titanium) and refractory, corrosion resistance and biocompatibility corresponding to that of pure tantalum or niobium, making them suitable for use as biomaterials (e.g. implants), prosthetic devices and dental implants.

In an embodiment of the present disclosure, the core material (e.g. titanium) can be plated with a copper or gold layer impervious to atomic, molecular and nascent hydrogen, followed by the deposition of a tantalum or niobium layer. Such composite materials are suitable, following loading with a suitable electrocatalyst, as dimensionally stable monopolar or bipolar industrial electrodes capable of withstanding hydrogen, oxygen and chlorine evolution, for applications including but not limited to electrolyzers, batteries, fuel cells and supercapacitors.

In an embodiment of the present disclosure, the core material (e.g. a porous shape memory alloy such as NiTiNOL) can be plated with a nickel or gold layer, followed by the deposition of a tantalum coating. Such composite materials comprise high surface area dimensionally stable electrodes suitable for use in applications not limited to batteries, fuel cells and supercapacitors.

In an embodiment, the composite materials of the present disclosure exhibit corrosion resistant properties corresponding to bulk tantalum, making them suitable for use as corrosion resistant materials for manufacturing applications including but not limited to heat exchanger plates, piping, valves, pumps, pump casings, impellers, tanks, and pressure vessels.

### Experimental

A number of examples are provided hereinbelow, illustrating the manufacture of the various parts of the high-strength composite materials of the present disclosure.

Surface Activation of Titanium and Titanium Alloys.

Rectangular plates of chemically pure titanium (ASTM grade 2) and of titanium alloy Ti-6Al-4V (ASTM grade 5) were first degreased using trichloroethylene, air dried and then sandblasted with fine corundum sand (90 μm) under a pressure of 5 MPa using a sandblasting unit (model Solo Basic) manufactured by Renfert GmbH. Prior to chemical etching in either (i) a boiling solution of oxalic acid (9 wt. % H₂C₂O₄), (ii) a hydrochloric acid solution (20 wt. % HCl), or (iii) a sulfuric acid solution (30 wt. % H₂SO₄) over a period of 30 minutes, the sandblasted plates were immersed in an ultrasound bath for removal of any imbedded abrasive sand particles. Alternatively, the chemical etching was performed over a period of 5 seconds using a mixture of nitric-hydrofluoric acids (60 vol. % HNO₃—20 vol. % HF—20 vol. % H₂O). The etched plates were then thoroughly washed with deionized water and kept therein until the deposition of the intermediate layer.

Surface Activation of Zirconium and Zirconium Alloys.

A rectangular plate of chemically pure zirconium (e.g. zircadyne grade 702) was first degreased using trichloroethylene, air dried and then sandblasted with a fine corundum sand (90 μm) under a pressure of 5 MPa using a sandblasting unit (model Solo basic) manufactured by Renfert GmbH. Prior to chemical etching in a mixture of nitric-hydrofluoric acids (60 vol. % HNO₃—20 vol. % HF—20 vol. % H₂O) over a period of 2 seconds and immersion in a stopping bath comprising a mixture of nitric and sulfuric acids (60 vol. % HNO₃—20 vol. % H₂SO₄—20 vol. % H₂O) over a period of 5 seconds, the sandblasted plate was immersed in an ultrasound bath for removal of any imbedded abrasive sand particles. The etched zirconium plates were then thoroughly washed with deionized water and kept therein until deposition of the intermediate layer.

Surface Activation of Nickel-Titanium Shape Memory Alloy (NiTiNOL).

A rod of shape memory nickel-titanium alloy (NiTiNOL; 55Ni-45Ti) was first degreased using trichloroethylene. The clean rod was then electropolished in a solution of sulfuric acid in methanol (e.g. 200 g/L H₂SO₄). The anode was comprised of the rod of shape memory alloy while the cathode was comprised of a platinum plate. The electropolishing was performed galvanostatically over a period of 30 seconds, until the cell voltage reached 60 V, at 5° C. with an anodic current density of 2 kA/m². The etched rod was then thoroughly washed with methanol and kept therein until deposition of the intermediate layer.

Surface Activation of a High Melting Point Aluminum-Scandium Alloy.

A rectangular plate of an aluminum-scandium alloy having a melting point above 800° C., was first degreased using acetone, air dried and then sandblasted with a fine corundum sand (90 μm) under a pressure of 5 MPa using a sandblasting unit (model Solo basic) manufactured by Renfert GmbH. Prior to chemical etching at room temperature in a mixture of nitric-hydrofluoric acids (20 vol. % conc. HNO₃—5 vol. % conc. HF—75 vol. % H₂O) over a period of 2 minutes, the sandblasted plate was immersed in an ultrasound bath for removal of any imbedded abrasive sand particles. The etched aluminum-scandium alloy plate was then thoroughly washed with deionized water and kept therein until deposition of the intermediate layer.

Surface Activation of a Magnesium and Magnesium Alloys.

A rectangular plate of magnesium metal was first degreased using acetone, air dried and then gently sandblasted with a fine corundum sand (90μm) under a pressure of 5 MPa using a sandblasting unit (model Solo basic) manufactured by Renfert GmbH. The sandblasted plate was immersed in an ultrasound bath for removal of any imbedded abrasive sand particles. The magnesium plate was then immersed in an alkaline zincate bath at room temperature comprising 500 g/L sodium hydroxide (NaOH) and 100 g/L zinc oxide (ZnO). Any oxide film at the surface of the magnesium plate was readily dissolved (exposing the magnesium metal) and was immediately replaced by a zinc layer providing a coherent layer ready for the electroplating the intermediate layer or intermediate coating layer.

Electrodeposition of an Intermediate Coating Layer of Nickel Onto Pure Titanium and Titanium Alloys.

A nickel strike plate ranging in thickness from about 1 to about 2 micrometers was first electrodeposited onto the previously surface activated titanium or titanium alloy plates using a modified Watts bath. The electrolyte consisted of an aqueous solution comprising 220 g/L of nickel (II) chloride hexahydrate and 40 g/L of concentrated hydrofluoric acid (50 wt. % HF). The electrodeposition was performed galvanostatically over a period of 5 minutes at 60° C. with a cathodic current density of 200 A/m². The electrolyzer was comprised of an undivided PVC tank in which the central titanium plate was the cathode and in which thick nickel plates surrounding the titanium plate functioned as soluble anodes. A nickel plate having a thickness of about several micrometers was then galvanostatically electroplated over a period of 1 hour at 60° C. by means of a cathodic current density of 200 A/m² using a classical Watts bath. The electrolyte consisted of an aqueous solution comprising 350 g/L of nickel (II) sulfate hexahydrate, 45 g/L of nickel (II) chloride hexahydrate, and 35 g/L of boric acid.

Electrodeposition of an Intermediate Coating Layer of Nickel Onto Pure Zirconium and Zirconium Alloys.

A nickel strike plate ranging in thickness from about 1 to about 2 micrometers was first electrodeposited onto the previously surface activated zirconium or zirconium alloy plates using a modified Watts bath. The electrolyte consisted of an aqueous solution comprising 220 g/L of nickel (II) chloride hexahydrate and 40 g/L of concentrated hydrofluoric acid (50 wt. % HF). The electrodeposition was performed galvanostatically over a period of 5 minutes at 60° C. with a cathodic current density of 200 A/m². The electrolyzer was comprised of an undivided PVDF tank in which the central zirconium plate was the cathode and in which thick nickel plates surrounding the zirconium plate functioned as soluble anodes. A nickel plate having a thickness of about several micrometers was then galvanostatically electroplated over a period of 1 hour at 60° C. by means of a cathodic current density of 200 A/m² using a classical Watts bath. The electrolyte consisted of an aqueous solution comprising 350 g/L of nickel (II) sulfate hexahydrate, 45 g/L of nickel (II) chloride hexahydrate, and 35 g/L of boric acid.

Electrodeposition of an Intermediate Coating Layer of Copper Onto Pure Zirconium and Zirconium Alloys.

A copper strike plate ranging in thickness from about 1 to about 2 micrometers was first electrodeposited onto the previously surface activated zirconium or zirconium alloy plates using an aqueous electrolyte comprising 250 g/L of copper (II) chloride hexahydrate and 50 g/L of concentrated hydrofluoric acid (50 wt. % HF). The electrodeposition was performed galvanostatically over a period of 5 minutes at 60° C. with a cathodic current density of 200 A/m². The electrolyzer was comprised of an undivided PVDF tank in which the central zirconium plate was the cathode and in which two thick plates of pure copper surrounding the zirconium plate functioned as soluble anodes. A copper plate having a thickness of about several micrometers was then galvanostatically electroplated over a period of 1 hour at 60° C. by means of a cathodic current density of 200 A/m² using a modified copper acid bath. The electrolyte consisted of an aqueous solution comprising 350 g/L of copper (II) sulfate, 50 g/L of sulfuric acid, and 10 g/L of hydrofluoric acid.

Electrodeposition of an Intermediate Coating Layer of Gold Onto Pure Zirconium and Zirconium Alloys.

A gold coating layer having a thickness of about several micrometers was electrodeposited onto the previously surface activated zirconium or zirconium alloy plates at a pH of about 12.1 using an aqueous electrolyte comprising 44 g/L of potassium dicyanoaurate [KAu(CN)₂], 48 g/L of potassium tartrate, 3 g/L of potassium hydroxide (KOH), 10 g/L of potassium carbonate (K₂CO₃) and finally 30 g/L of potassium cyanide (KCN). The electrodeposition was performed galvanostatically at 54° C. with a cathodic current density of 215 A/m². The electrolyzer was comprised of an undivided PVDF tank in which the central zirconium plate was the cathode and in which two thick plates of pure gold (for low current density applications) surrounding the zirconium plate functioned as soluble anodes. Alternatively, the electrolyzer was comprises of an undivided PVDF tank in which the central zirconium plate functioning as the cathode was surrounded by two insoluble anodes comprised of stainless steel (AISI 304L).

Electrodeposition of an Intermediate Coating Layer of Gold Onto a High Melting Point Aluminum-Scandium Alloy.

A gold layer having a thickness of about several micrometers was electrodeposited onto the previously surface activated aluminum-scandium alloy at a pH of about 12.1 using an aqueous electrolyte comprising 44 g/L of potassium dicyanoaurate [KAu(CN)₂], 48 g/L of potassium tartrate, 3 g/L of potassium hydroxide (KOH), 10 g/L of potassium carbonate (K₂CO₃) and finally 30 g/L of potassium cyanide (KCN). The electrodeposition was performed galvanostatically at 54° C. with a cathodic current density of 215 A/m². The electrolyzer was comprised of an undivided PVDF tank in which the central aluminum-scandium alloy was the cathode and in which two thick plates of pure gold (for low current density applications) surrounding the aluminum-scandium alloy functioned as soluble anodes. Alternatively, the electrolyzer was comprised of an undivided PVDF tank in which the central aluminum-scandium alloy functioning as the cathode was surrounded by two insoluble anodes comprised of stainless steel (AISI 304L).

Electrodeposition of an Intermediate Coating Layer of Nickel Onto Pure Magnesium and Magnesium Alloys.

A nickel strike plate was first deposited onto the previously surface treated (zincate bath) magnesium or magnesium alloy. A nickel plate having a thickness of about several micrometers was then galvanostatically electroplated over a period of 1 hour at 60° C. by means of a cathodic current density of 200 A/m² using a classical Watts bath. The electrolyte consisted of an aqueous solution comprising 350 g/L nickel (II) sulfate hexahydrate, 45 g/L of nickel (II) chloride hexahydrate, and 35 g/L of boric acid.

Heat Treating and Diffusion Bonding.

In order to ensure a tight bond between the substrate and the intermediate layer or intermediate coating layer, the electroplated core materials were heat treated at temperatures ranging from about 500° C. to about 900° C., either under vacuum or inert atmosphere, ensuring diffusion bonding between all layers. The heating may be provided by means of direct heating, induction heating, Joule's heating, immersion in a molten salt or plasma heating. In light of the present disclosure, it is believed to be within the capacity of a skilled technician to determine and select other suitable heating methods.

Electrodeposition of Tantalum by Molten Salt Electrolysis.

A thin tantalum coating layer was electrodeposited onto the previously heat treated electroplated core materials by means of electrolysis in a molten salt electrolyte, at temperatures of about 800° C. and under an inert argon or helium atmosphere. The molten salt electrolyte comprised a binary mixture of lithium and sodium fluorides having the eutectic composition 60 mol. % LiF—40 mol. % NaF and 40 wt. % potassium heptafluorotantalate (K₂TaF₇). The previously heat treated electroplated core materials were immersed in the bath and cathodically polarized while a thick tantalum crucible containing the melt functioned as tantalum soluble anode. The electrodeposition was performed under galvanostatic control using a direct current power supply at a cathodic current density of 500 A/m². The tantalum coated material was removed from the reactor by means of an antechamber which was closed by a large valve gate, avoiding any entry of air and moisture. Once cooled, the coated material exhibited a dense, coherent, impervious and thin tantalum protective layer having corrosion properties identical to pure tantalum metal.

Electrodeposition of Tantalum by Metalliding.

A thin tantalum coating layer was electrodeposited onto the previously heat treated nickel-electroplated core materials by means of metalliding in a molten salt electrolyte, at temperatures of about 800° C. and under an inert argon or helium atmosphere. The molten salt electrolyte comprised a binary mixture of lithium and sodium fluorides having the eutectic composition 60 mol. % LiF—40 mol. % NaF and 40 wt. % potassium heptafluorotantalate (K₂TaF₇). The previously heat treated nickel-electroplated core materials were immersed in the bath. The cathode (i.e. the heat treated nickel-electroplated core materials) and the tantalum soluble anode (i.e. the tantalum crucible containing the melt) were electrically connected without the use of a power supply, the difference between the electrode potentials being the driving-force. The metalliding process was carried out over a period of several hours, resulting in a diffusion bonded tantalum-nickel alloy coated material. The tantalum coated material was removed from the reactor by means of an antechamber which was closed by a large valve gate, avoiding any entry of air and moisture. Once cooled, the coated material exhibited a dense, coherent, impervious and thin diffusion bonded tantalum-nickel alloy protective layer having excellent corrosion properties.

It is to be understood that the disclosure is not limited in its application to the details of construction and parts as described hereinabove. The disclosure is capable of other embodiments and of being practiced in various ways. It is also understood that the phraseology or terminology used herein is for the purpose of description and not limitation. Hence, although the present disclosure has been described hereinabove by way of illustrative embodiments thereof, it can be modified, without departing from its spirit, scope and nature as defined in the appended claims.

### REFERENCES

1. Niinomi, M. Recent metallic materials for biomedical applications. Metallurgical and Material Transactions A, 33A (2001), 477-486.
2. ASTM F138-03; Specification for Wrought-18Chromium-14Nickel-2.5Molybdenum Stainless Steel Bar and Wire for Surgical Implants (UNS S31673). American Society for Testing and Materials, West Conshohocken, Pa.
3. ASTM F75-01; Specification for Cobalt-28Chromium-6Molybdenum Alloy Castings and Casting Alloy for Surgical Implants (UNS R30075). American Society for Testing and Materials, West Conshohocken, Pa.
4. Park, J. B.; Bronzino, J. D. (ed.) (2000). The Biomedical Engineering Handbook, Vol. 1. CRC Press Bocca Raton, Fla., pp. IV-1 to IV-8.
5. ASTM F67-00; Specification for Unalloyed Titanium for Surgical Implant Applications (UNS R50250, UNS R50400, UNS R50550, UNS R50700). American Society for Testing and Materials, West Conshohocken, Pa.
6. ASTM F136-02a; Standard Specification for Wrought Titanium-6 Aluminum-4 Vanadium ELI (Extra Low Interstitial) Alloy for Surgical Implant Applications (UNS R56401). American Society for Testing and Materials, West Conshohocken, Pa.
7. ASTM F2063-05; Standard Specification for Wrought Nickel-Titanium Shape Memory Alloys for Medical Devices and Surgical Implants. American Society for Testing and Materials, West Conshohocken, Pa.
8. Ferguson et al. Journal of Bone and Joint Surgery, 41A (1959), 737.
9. Ferguson et al. Journal of Bone and Joint Surgery, 42A (1960), 77. Ferguson et al. Journal of Bone and Joint Surgery 44A 323, 1962. Ferguson et al. Journal of Biomedical Materials Research 1, 135, 1967.
10. Schider, S.; Plenk, H.; Pfluger, G.; Otte, H.; and Ennenmoser, K. Tantalum and niobium, two new materials for implants in comparison with other implant materials. Metall. 35(10), (1981), 1011-1018.
11. Black, J. Biological performance of tantalum. Clinical Materials, 16, (1994), 167-173.
12. Cardarelli, F.; Taxil, P.; and Savall, A. Tantalum protective thin coating techniques for the chemical process industry: molten salts electrocoating as a new alternative. International Journal of Refractory Metals & Hard Materials, 14(5-6), (1996), 365-381.
13. Cardarelli, F.; Comninellis, C.; Savall, A.; Taxil, P.; Manoli, G.; and Leclerc, O. Preparation of oxygen evolving electrodes with long service life under extreme conditions. Journal of Applied Electrochemistry, 28(3)(1998)245-250.
14. Banker, J. G.; and Reineke, E. G. “Explosion Welding”, in ASM Handbook 10^{th}. Ed., Vol. 6, Welding, Brazing, and Soldering, 1993, ASM International Materials Park, Ohio, pp. 303-305.
15. Kumagai, N.; Jikihara, S.; Samata, Y.; Asami, K; and Hashimoto, A. M. The effect of sputter-deposited Ta intermediate layer on durability of IrO2-coated Ti electrodes for oxygen evolution. Proceeding of the 183^{rd} Joint International Meeting of The Electrochemical Society, Session 93-30 (Corrosion, Electrochemistry, and Catalysis of Metastable Metals and Intermetallics), Abstract 324-33, Honolulu, Hi., May 16-21, 1993.
16. Cardarelli, F. (2001). Materials Handbook. A Concise Desktop Reference. Springer, N.Y., London.

What is claimed is:

1. A lightweight, corrosion resistant composite metallic material comprising:
a) a high strength-to-weight ratio, low density core material; and
b) a refractory, corrosion resistant protective layer.

2. The composite metallic material of claim 1, further comprising an intermediate layer disposed between said core material and said protective layer.

3. The composite metallic material of claim 1, wherein said protective layer comprises a coating layer.

4. The composite metallic material of claim 2, wherein said intermediate layer comprises a coating layer.

5. The composite metallic material of claim 1, wherein said core material comprises a material selected from the group consisting of base metals, base metal alloys, shape memory alloys and mixtures thereof.

6. The composite metallic material of claim 1, wherein said core material comprises a material selected from the group consisting of metal matrix composites and carbon-based materials.

7. The composite metallic material of claim 5, wherein said core material is selected from the group consisting of titanium metal, titanium alloys, zirconium metal, zirconium alloys, aluminum metal, aluminum alloys, scandium metal, scandium alloys, magnesium metal, magnesium alloys, high melting point aluminum-scandium alloys and mixtures thereof.

8. The composite metallic material of claim 5, wherein said shape memory alloys comprise NITINOL.

9. The composite metallic material of claim 6, wherein said metal matrix composites comprise a material selected from the group consisting of magnesium, aluminum, titanium and alloys thereof, said material being reinforced by fibres selected from the group consisting of carbon (C), boron carbide (B₄C), silicon carbide (SiC) and mixtures thereof.

10. The composite metallic material of claim 6, wherein said carbon-based materials comprise pyrrolytic graphite.

11. The composite metallic material of claim 3, wherein said protective layer comprises a material selected from the group consisting of titanium metal, titanium alloys, zirconium metal, zirconium alloys, hafnium metal, hafnium alloys, vanadium metal, vanadium alloys, niobium metal, niobium alloys, tantalum metal, tantalum alloys, chromium metal, chromium alloys, molybdenum metal, molybdenum alloys, tungsten metal, tungsten alloys, iridium metal, iridium alloys, rhenium metal, rhenium alloys and mixtures thereof.

12. The composite metallic material of claim 4, wherein said intermediate layer comprises a material selected from the group consisting of iron, iron alloys, nickel, nickel alloys, cobalt, cobalt alloys, copper, copper alloys, gold, gold alloys, chromium, chromium alloys, platinum group metals, platinum group metal alloys and mixtures thereof.

13. The composite metallic material of claim 12, wherein the platinum group metals are selected from the group consisting of ruthenium, rhodium, palladium, osmium, iridium, and platinum.

14. A process for preparing a lightweight, corrosion resistant composite metallic material, said process comprising:
a) providing a high strength-to-weight ratio, low density core material; and
b) providing said core material with a refractory, corrosion resistant protective layer.

15. The process of claim 14, further comprising:
c) surface activating said core material to produce a surface activated core material; and
d) providing said surface activated core material with an intermediate layer.

16. The process of claim 14, wherein said protective layer comprises a coating layer.

17. The process of claim 15, wherein said intermediate layer comprises a coating layer.

18. The process of claim 15, wherein said surface activating comprises:
a) washing said core material by a means selected from the group consisting of an organic solvent, a caustic alkaline solution and electrocleaning;
b) abrading said core material to provide an abraded surface; and
c) etching said abraded surface.

19. The process of claim 18, wherein said organic solvent is selected from the group consisting of hexanes, acetone, trichloroethylene, dichloromethane and mixtures thereof.

20. The process of claim 18, wherein said caustic alkaline solution comprises potassium hydroxide in ethanol.

21. The process of claim 18, wherein said abrading is performed by means of a method selected from the group consisting of sandblasting and grinding.

22. The process of claim 16, wherein said protective layer is deposited by a method selected from the group consisting of electrolysis, electroless plating, currentless electrolysis, physical deposition and chemical deposition.

23. The process of claim 16, wherein said core material comprises a material selected from the group consisting of base metals, base metal alloys, shape memory alloys and mixtures thereof.

24. The process of claim 16, wherein said core material comprises a material selected from the group consisting of metal matrix composites and carbon-based materials.

25. The process of claim 23, wherein said core material is selected from the group consisting of titanium metal, titanium alloys, zirconium metal, zirconium alloys, aluminum metal, aluminum alloys, scandium metal, scandium alloys, magnesium metal, magnesium alloys, high melting point aluminum-scandium alloys and mixtures thereof.

26. The process of claim 23, wherein said shape memory alloys comprise NiTiNOL.

27. The process of claim 24, wherein said metal matrix composites comprise a material selected from the group consisting of magnesium, aluminum, titanium and alloys thereof, said material being reinforced by fibres selected from the group consisting of carbon (C), boron carbide (B₄C), silicon carbide (SiC) and mixtures thereof.

28. The process of claim 24, wherein said carbon-based materials comprise pyrrolytic graphite.

29. The process of claim 16, wherein said protective layer comprises a material selected from the group consisting of titanium metal, titanium alloys, zirconium metal, zirconium alloys, hafnium metal, hafnium alloys, vanadium metal, vanadium alloys, niobium metal, niobium alloys, tantalum metal, tantalum alloys, chromium metal, chromium alloys, molybdenum metal, molybdenum alloys, tungsten metal, tungsten alloys, iridium metal, iridium alloys, rhenium metal, rhenium alloys and mixtures thereof.

30. The process of claim 17, wherein said intermediate layer is deposited by a method selected from the group consisting of electrolysis, electroless plating, currentless electrolysis, physical deposition and chemical deposition.

31. The process of claim 17, wherein said intermediate layer comprises a material selected from the group consisting of iron, iron alloys, nickel, nickel alloys, cobalt, cobalt alloys, copper, copper alloys, gold, gold alloys, chromium, chromium alloys, platinum group metals, platinum group metal alloys and mixtures thereof.

32. The process of claim 31, wherein the platinum group metals are selected from the group consisting of ruthenium, rhodium, palladium, osmium, iridium, and platinum.

33. Use of the lightweight, corrosion resistant composite metallic material of claim 1 as devices in biomedical applications.

34. The use of claim 33, wherein said devices are selected from the group consisting of prosthetic devices and dental implants.

35. Use of the lightweight, corrosion resistant composite metallic material of claim 1 for manufacturing industrial electrodes.

36. The use of claim 35, wherein said industrial electrodes comprise a use in applications selected from the group consisting of batteries, fuel cells, electrolyzers and supercapacitors.

37. Use of the lightweight, corrosion resistant composite metallic material of claim 1 for manufacturing corrosion resistant materials.

38. The use of claim 37, wherein said corrosion resistant materials comprise a use in manufacturing applications selected from the group consisting of piping, valves, pumps, pump casings, impellers, tanks, and pressure vessels.
